(19) United States
(12) Patent Application Publication
(10) Pub. No.: US 2017/0024692 A1
(43) Pub. Date: Jan. 26, 2017

(54) FOOD TRACKING AND PACKAGING METHOD AND APPARATUS

(71) Applicants: Mark Sambrailo, Watsonville, CA (US); Erik Sambrailo, Aptos, CA (US); Thomas Taggart, Hollister, CA (US)

(72) Inventors: Mark Sambrailo, Watsonville, CA (US); Erik Sambrailo, Aptos, CA (US); Thomas Taggart, Hollister, CA (US)

(21) Appl. No.: 15/011,478

(22) Filed: Jan. 29, 2016

Related U.S. Application Data
(60) Provisional application No. 62/109,160, filed on Jan. 29, 2015.
(60) Provisional application No. 62/275,721, filed on Jan. 6, 2016.

(51) Int. Cl. G06Q 10/08; G06K 7/14

(52) U.S. Cl. CPC G06Q 10/0833; G06K 7/1417

(57) ABSTRACT

The invention encompasses methods and apparatuses for tracking and tracing containers and their contents in a supply chain. Inventions disclose apparatuses capable of scanning multiple containers while in a tray having viewing windows. An associated tray and container for accommodating such scanning is also disclosed. Also disclosed are methods for tracking and tracing the scanned containers and contents.

### CROSS-REFERENCE TO RELATED APPLICATIONS

This application claims priority to a provisional patent application entitled “Food Packaging Container and Tracking Method and Apparatus,” Application No. 62/109,160, filed on Jan. 29, 2015 and which is hereby incorporated by reference in its entirety for all purposes.

This application further claims priority to a provisional patent application entitled “Food Tracking and Packaging Method and Apparatus,” Application No. 62/275,721, filed on Jan. 6, 2016 and which is hereby incorporated by reference in its entirety for all purposes.

### TECHNICAL FIELD

The present invention relates to improved methods product tracking and packaging configurations. In some implementations, the inventions disclosed here teach methods and apparatus for improving the packaging, storage, shipping, and tracking of produce and other items. Also, importantly, this patent discloses technologies that provide increased traceability of products from origin to end user and beyond. With one implementation directed to traceability/tracking from harvest through a supply chain to end users and beyond to include follow on information. The inventions disclosed herein provided enhanced food safety.

### BACKGROUND

Currently, when certain types of agricultural produce products (also referred to herein as produce) are harvested and/or when they are processed they can be shipped in plastic containers that enable transit through distribution channels. Attempts have been made to track the transit of these packages through some portions of a transit chain. Thus far effective tracking has proven elusive. Problems such as mislabeling and insufficient supply chain tracking are currently rampant in the industry. In current technologies, many sources of error and confusion exist. These degrade the ability to track the produce throughout supply chain. Problems also exist in produce traceability resulting in an inability to assure food safety. For example, in one approach, a pre-packaged set of containers is identified and placed in a holder which associates the containers and holder as a set. Each set is shipped to the field where the containers can be loaded with produce and returned to their parent holder. The produce is tracked by the management of the holder. One problem with this approach is it easily disrupted, leading to tracking errors. For example, if a group of holders is knocked over, the containers fall out and are scattered, once they are re-collected and placed back in trays, the association are lost as is the ability to track the containers. Thus, the tracking information is now meaningless because the containers can no longer be associated with the appropriate tray. There are other technologies with similar shortcomings or problems. It would be helpful to have a reliable, repeatable, efficiently useable, and more complete way to track these containers as they pass through the supply chain.

### SUMMARY OF THE INVENTION

In accordance with the principles of the present invention, an improved apparatus and method for packaging, transporting, and tracking items in a container having is disclosed.

In general, the present invention is directed toward methods of packaging items and tracking their progress in a supply chain as well as enhancing the traceability of the items through the place of origin to the consumer and beyond. When used in an agricultural context such traceability enables effective produce tracking and increases food safety and the enables after sale product information to be obtained from end users. As generally understood here, a supply chain refers to all points of transit and processing from the beginning of tracking with the disclosed technologies until it reaches the end user and, if desired, can include post sale information.

In one embodiment, a method for tracking a container filled with an item is described. Such a method provides each container with a machine readable unique identifier code. The containers are filled with items and then placed with a tray having a viewing window. The unique identifier codes are scanned through the viewing window and associating with a data record for the container. This data record and unique identifier code can then be used to track the container and contents throughout desired portions of a supply chain.

In another embodiment, a scanning system is disclosed. One such system comprises a scanning bed for supporting a tray that holds containers. The tray and containers arranged to enable viewing of identifier codes of the containers through a viewing window of the tray. The apparatus includes an identification system (that can include an imaging system, and RFID system, or other identification system) for reading identifier codes through the viewing window. Moreover, the apparatus includes a processor for processing the identifier codes and associated each code with a data record that also includes related metadata concerning the container, and includes a memory for storing data record.

In another embodiment, a packaging system is disclosed. The system includes a packaging tray having at least one viewing window and a plurality of containers, each container having an identifier code arranged thereon. Each of the containers are sized and arranged in the tray such that the identifier code is viewable through the viewing window of the tray.

Other aspects and advantages of the invention will become apparent from the following detailed description and accompanying drawings which illustrate, by way of example, the principles of the invention.

### BRIEF DESCRIPTION OF THE DRAWINGS

The following detailed description will be more readily understood in conjunction with the accompanying drawings, in which:

FIG. 1 is a simplified perspective view of a packaging container with unique identifier code in accordance with one embodiment of the present invention.

FIGS. 2A & 2B comprise a pair of different perspective views of novel tray embodiments used to hold containers in accordance with one embodiment of the present invention.

FIG. 2C is a simplified section view of an embodiment of a packaging tray having protective window overlying a viewing window of the tray in accordance with one embodiment of the present invention.

FIG. 3A is an exaggerated perspective view of a set of containers showing a relative orientation between the containers and viewing windows of an associated tray in accordance with one embodiment of the present invention.

FIG. 3B is a perspective view of an underside of a tray filled with a set of containers showing a relative orientation between the containers and viewing windows of the tray in accordance with an embodiment of the present invention.

FIG. 4 is a perspective view of an embodiment of a scanning apparatus with a filled tray in readiness for setting upon the scanning apparatus such that it can be scanned in accordance with the principles of the invention.

FIG. 5 is a simplified schematic view of an embodiment of a processing system usable in a scanning apparatus such as described herein.

FIGS. 6A-6B are simplified plan and perspective views of an embodiment of a scanning apparatus suitable for implementing certain aspects of the invention.

FIGS. 7A-7B are simplified plan and perspective views of another embodiment of a scanning apparatus suitable for implementing certain aspects of the invention.

FIG. 8 is a simplified schematic block diagram illustration aspects of a scanning apparatus constructed in accordance with the principles of the invention.

FIG. 9 is a simplified block diagram illustrating aspects of a data record generation implementation and a tracking embodiment in accordance with one embodiment of the present invention.

FIG. 10 is simplified perspective view of a pallet loaded with containers and trays of certain embodiments of the invention.

FIG. 11 is a schematic flow diagram embodiment showing some aspects of product and container tracking in accordance with certain aspects of the invention.

It is to be understood that in the drawings like reference numerals designate like structural elements. Also, it is understood that the depictions in the Figures are not necessarily to scale.

### DETAILED DESCRIPTION OF THE INVENTION

The present invention comprises novel approach of achieving product tracking, management and traceability as. In particular, embodiments of the invention use novel packaging approaches applying novel devices, materials and methods. Accordingly, the present invention has been particularly shown and described with respect to certain embodiments and specific features thereof. The embodiments set forth hereinbelow are to be taken as illustrative rather than limiting. It should be readily apparent to those of ordinary skill in the art that various changes and modifications in form and detail may be made without departing from the spirit and scope of the invention.

The inventions described herein can be applied to both, supply chain tracking and management, as well as product traceability from the beginning of a supply chain to an end user and beyond.

As used generally herein, “Tracking” can apply to supply chain management enabling the management and tracking of products or other items in a supply chain. In one implementation, such tracking can improve the logistical management of products in a supply chain although tracking is not limited to such.

An aspect of tracking is “Traceability” which is the ability to follow and quantify various aspects of a product from a desired origin to an end user (such a consumer) and beyond. This has particular utility in following after market consumer information. Additionally, it enables a user, after the fact, to trace a path of the product through the supply chain and discern the product conditions and characteristics over time. When applied in the agricultural industry it can be used to enhance food safety and identify food safety issues at any place along a supply chain, even after end use. Such traceability can enable consumer feedback concerning the products. Thus, from any desired point in a product's life the product can be traced along a supply path back to its origin and a number of pieces of information can be obtained regarding the tracked product along the path.

The inventions disclosed herein address one of the main problems in supply chain management, the ability to reliably track products through a supply chain and to trace where products have been. Although the inventions discussed herein are broadly applicable to most industries and supply chains, the invention will be illustrated herein using agricultural products as the specific example. In the agricultural industry there is a need for reliably tracking and tracing produce products through the supply chain from the fields to the supermarket to the end consumer and beyond. Existing systems have attempted to provide such tracking, but all known systems fail in real world applications. They cannot compensate for handling errors in the field or other transit problems that cause errors throughout the system. Such errors can be introduced at harvesting, when produce is loading onto pallets and at every other point in the transit and supply chain including the retail locations. Problems include mislabeling of items in the field, confusion between container lots, losing track of items, disrupted tracking systems, and many other such problems. The disclosed inventions teach improved methodologies and apparatus enabling far higher accuracy, reliability, and traceability.

The disclosed technology offers solutions to these problems. In one important implementation, the inventive technology described here does not require any prior associations or relationships between a container, the items in it, or a transit package (e.g., a tray, a pallet, etc.) until a desired point in a supply chain. Although, not limited to this example, the tracking can begin as early as in the field where a produce product is harvested. Moreover, independently acquired containers, can be used without regard for container origin. Thus, they can come from a vast array of previously unrelated sources. In a most generalized application, the container is scanned and associated with its contents at a selected point in a supply and/or transit chain then subject to tracking and processed from that point on. This approach results in much higher reliability tracking and accountability than can be achieved for existing technologies. Moreover, the container and its contents can be further associated with specific mass transit features such as pallets, trucks, train cars, ships as well as many other trackable features and modes of transport.

As generally disclosed, the invention includes a way of tracking a product through a supply chain and enabling the product to be traced back through its supply chain. As indicated above, one preferred application being directed to agricultural produce.

The invention can include a tracking system that can include at least one of a reading scanning system, and a container type, a tray type. The system can further comprise a database concerning each container and the contents of the container. Moreover, the system can be further comprised other reading scanning systems arranged at various points in a supply chain and after end use.

Another aspect of the invention is novel type of type of container and the position of unique identifiers on the container for use in accordance with the principles of the invention. This container, coupled with a novel tray, comprises another inventive aspect.

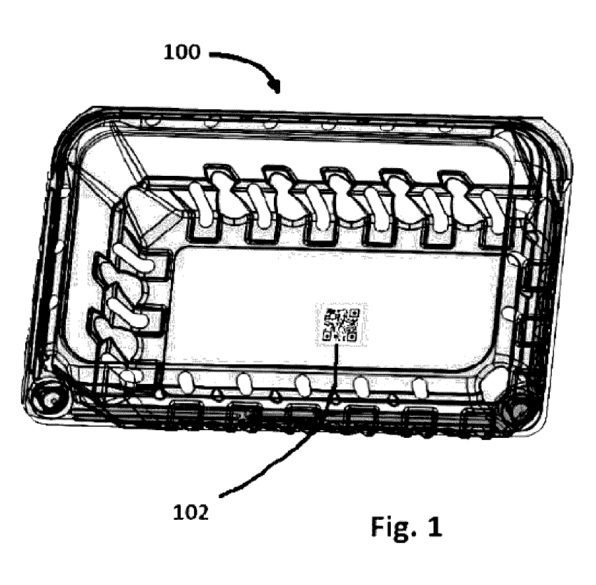

The disclosure now addresses a novel container embodiment. FIG. 1 shows one example of a type of container 100 suitable for use with the principles of the invention. Such a container can be of any type, but preferably with standard agricultural produce containers. Each container has a machine readable unique identifier 102 (a unique identifier code (UIC) 102) arranged somewhere on the container. Here the identifier 102 is located at the bottom of the container 100. Other embodiments can locate the identifier 102 elsewhere on the container, if needed. Many different types of identifiers can be used. In some embodiments, the machine-readable identifiers 102 comprise data representations such as bar codes or other readily readable product tracking information. So-called 1D and 2D barcode identifiers are useful due to their common usage. A full range of different bar code types and methodologies can be used. Common UPC identifiers can be used as well. So can RFID tags or other tracking identifiers. The UIC 102 can be placed on a label and adhered to the container 100. It can also be direct printed onto the container as well stamped into the container as well as many other modes of marking such as are known to those having ordinary skill in the art. An important feature of the container 100, is that the UIC 102 is readily readable from outside a transit media (e.g., a tray or box) while it is held by the media.

One example of a container 100 embodiment can be formed by using a thermo-formed plastic structure with a paper label having a UIC 102 adhered to a bottom surface of the container 100. However, it is contemplated that many different alternative materials and manufacturing technologies can be employed to form containers in accordance with the principles of the invention.

Example containers 100 can be formed of thermosetting plastic, for example a thermoformed PET Copolyester can be used. However, many alternative materials can be used. A few examples include, but not limited to, various polymeric and monomeric plastics including but not limited to styrenes, polyethylenes including HDPE and LPDE, polyesters and polyurethanes; and also more generally polyolefins, polyamids, polyacrylates, polyarylates, polysulfones, polyetherketones, polycarbonates, acrylics, polyphenylene sulfides, liquid crystal polymers, acetalscellulosics, polyetherimides, polyphenylene ethers/oxides, styrene maleic anhydride copolymers, styrene acrylonitrile copolymers, polyvinyl chlorides, polyvinyl alcohols, and the engineered resins thereof. Such materials can also include recycled plastic materials (RPET); metals and foils thereof; paper products including chipboard, pressboard, and flakeboard; wood; other post consumer recycled materials; and combinations of the foregoing. The depicted container may be formed using thermoforming. However, many alternative manufacturing technologies can be used including, but not limited to, casting (including die-casting); thermocasting; thermosetting; extrusion; vacuum forming; injection molding; blow molding; rotation molding; sintering; lamination; 3-D sculpting, the use of built-up structures and other processes well known to those of ordinary skill in the art. Other useful materials include but are not limited to flexible plastic film materials such as are used in plastic bags or other containers.

Another important attribute of the invention is a particular type of container holding and transport vessel. The produce packaging industry uses packaging trays to hold and ship containers such as those described with respect to FIG. 1. And important feature of one of the inventions disclosed herein is a novel type of tray for holding the containers described herein. Importantly, these trays include a viewing window arranged to enable a scanning system to scan, contemporaneously, all of the UIC's 102 of containers 100 loaded in the tray.

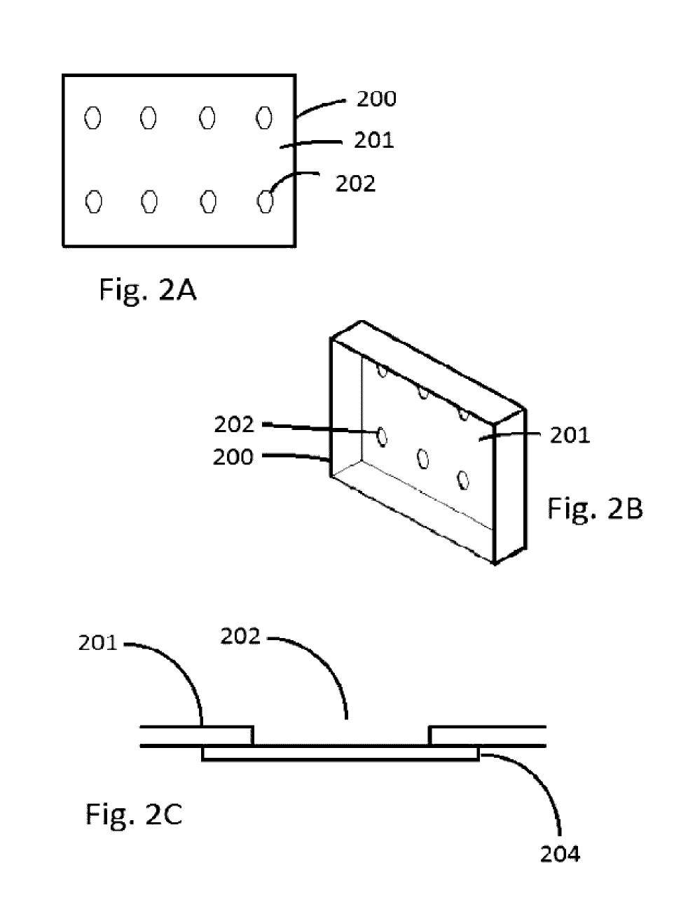

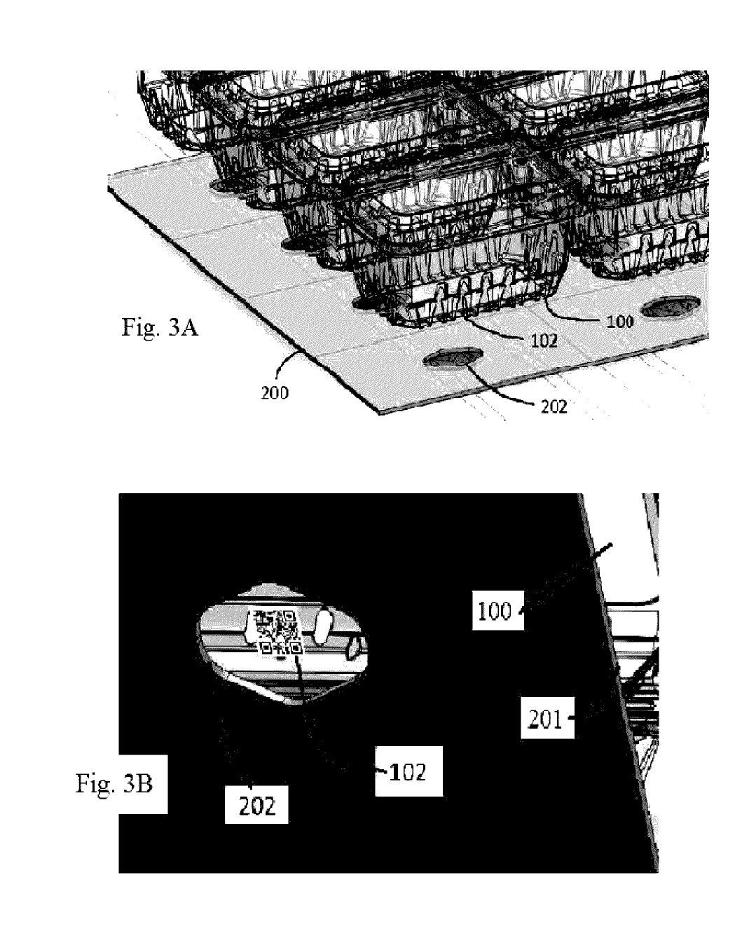

FIGS. 2A-2C depict several different views of a tray 200 embodiment that can be used in accordance with the principles of the invention. This embodiment is but one of many possible implementations. The tray 200 shown here is suitable for holding containers 100 in a manner consistent with the principles of the invention.

FIG. 2A depicts a plan view of a bottom surface 201 of a suitable tray 200. The tray includes a viewing window 202 through which a container UIC 102 can be viewed when placed in the tray 200. In this embodiment, the tray 200 includes several viewing windows 202. FIG. 2B is a perspective view showing the inside of the tray 200 and also a plurality of viewing windows 202 in the bottom surface 201. The idea being that containers 100 are loaded into the tray 200. The tray 200 is sized and configured such that the UIC's 102 of the containers 100 can be viewed through the window(s) 202 when the containers 100 are loaded in the tray 200. The viewing windows 202 are sized to enable ready viewing of the identifier codes 102 of containers 100 placed in the tray 200. Many different shapes, sizes, and configurations of windows 202 are contemplated. In a preferred embodiment, the viewing windows 202 are large enough to view the UIC's 102 even if some degree of misalignment occurs between the containers 100 of the tray 200. Embodiments can include trays 200 having viewing windows 202 large enough to view more than one UIC 102 through the same window 202. Additionally, in some embodiments, a window 202 can be large enough to enable all of the UIC's 102 to be viewed for all the containers 100 loaded in the tray 200.

FIG. 2C is a partial section view of a bottom portion 201 of a tray 200 showing a protective layer 204. In this embodiment the tray 200 has protective window coverings for the viewing windows 202. Suitable window(s) coverings 204 are optically transparent allowing the UIC's 102 to be scanned or otherwise viewed through the viewing windows 202. As indicated above, some embodiments can use protective window coverings 204 formed of transparent materials comprising a sheet of transparent plastic (or other material) overlaying the bottom 201 of the tray 200 covering the window 202 in the bottom of a tray 200. In one implementation, a plastic laminate formed of substantially transparent PET materials can be used. Additionally, as hinted at above, the invention contemplates an entire bottom portion of the tray 200 comprised of a transparent material that can expose all of the identifiers 102 of the loaded containers 100 at the same time.

The invention also contemplates embodiments where substantial portions (but not all) of the bottom surface 201 of the tray 200 are optically transparent.

Additionally, and importantly, the viewing windows 202 can be arranged at other locations on the tray 200. In this depicted embodiment, the windows 202 are arranged at the bottom surface 201 of the tray. However, depending on the location and orientation of a UIC 102 on a container, the viewing windows 202 can be arranged anywhere including sidewalls, or even tray covers or tops. The idea being to enable operative combination of tray 200 and container 100 such that the UIC's 102 can be viewed through the viewing windows 202 thereby enabling group scanning or other types of imaging to be performed from external to the tray 200 through the windows 202. It is specifically, pointed out here that these are merely examples with the inventions encompassing further implementations.

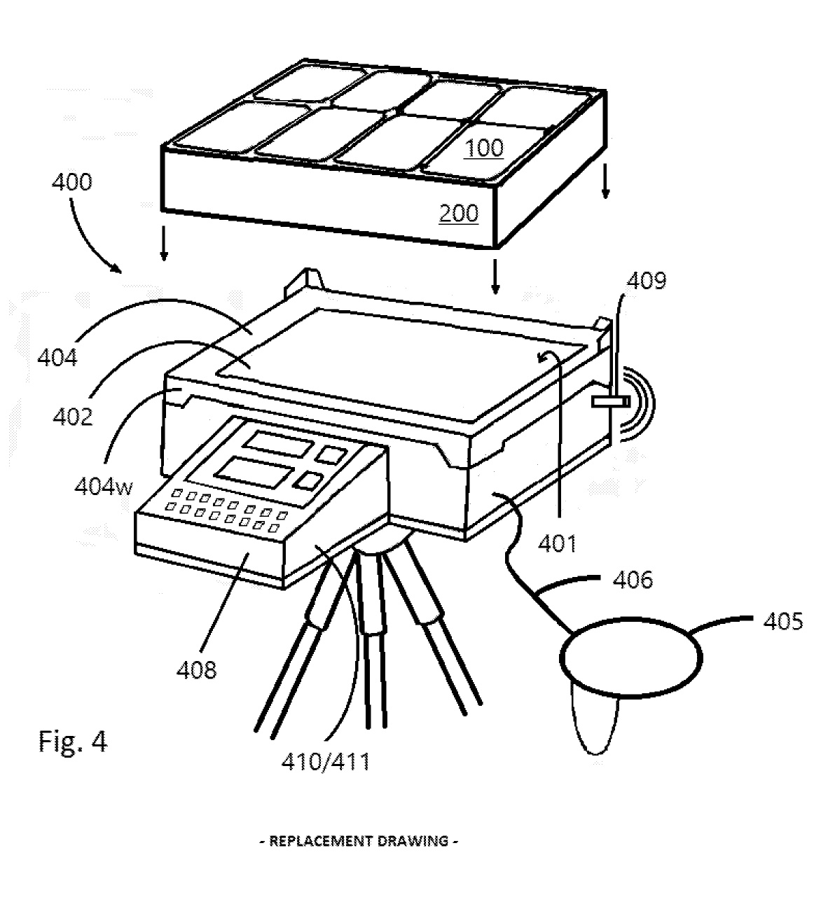

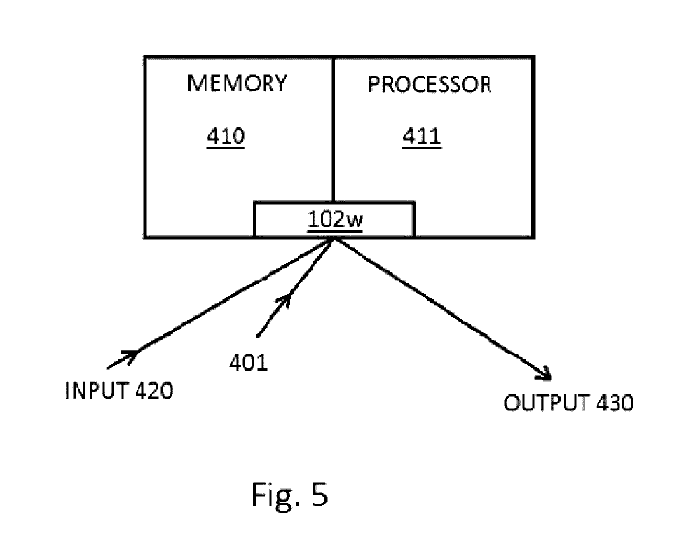

FIGS. 3A & 3B provide two views of trays 200 and associated containers 100 and operative combinations thereof. FIG. 3A is a cut away depiction of a tray 200 with a number of containers 100 arranged slightly above their location where they are loaded into the tray 100. In this view, the tray sidewalls are cut away for enhanced view of the containers 100 and tray bottom 201. Accordingly, the containers 200 are arranged just above their intended position when they are loaded in the tray 100. The viewing windows 202 are arranged and sized such that when the containers 100 are placed inside the tray 200 the identifiers 102 are to be visible through the viewing windows 202 (shown here at the bottom surface 201 of the tray 200).

FIG. 3B is view of the bottom of a loaded tray 200 showing the operative combination of containers 100 arranged in a tray 200 in accord with an embodiment of the invention. To that end, the viewing windows 202 are sized such that the coded identifiers 102 can be seen through them. In one embodiment, the windows 202 can be sized large enough so that the identifiers 102 can be read through the windows 201 even when the containers 100 have slightly misaligned identifiers 102 or when the containers 100 are misaligned when set in the tray. In some preferred embodiments, the openings are sized large enough such that the coded identifiers 102 can be still be read through the openings even though the position of the containers shifted during shipping. Thus, this embodiment contemplates a configuration and process that is robust to some degree of imperfection.

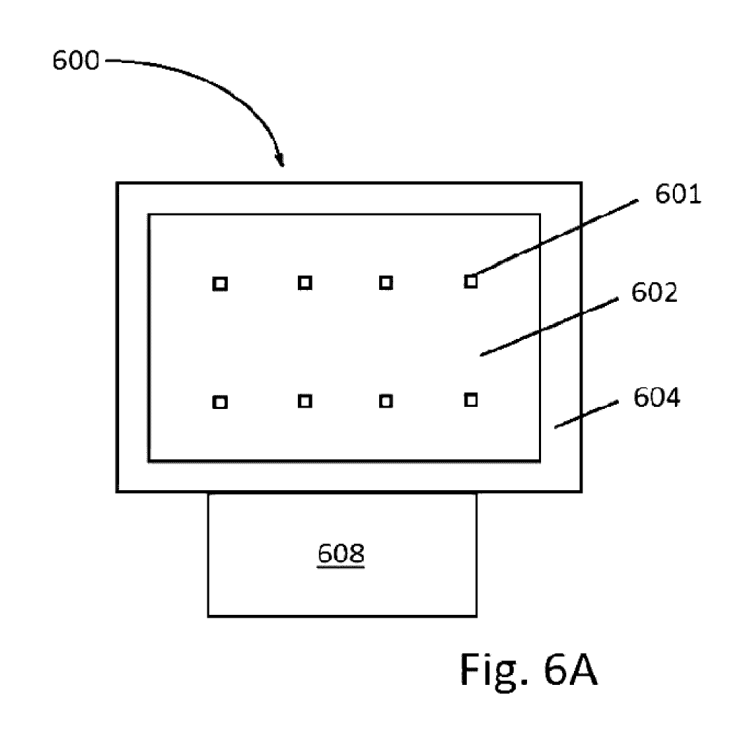

FIG. 4 is a schematic depiction of one generalized and highly simplified embodiment of a scanning apparatus 400 in accordance with the principles of the invention. In this embodiment, a plurality of containers 100 are arranging in a tray 200 such that their UIC's 102 are on the bottom exposed through the viewing windows of the tray 200. The apparatus 400 includes one or more optical element(s) 401 configured to enable reading (scanning) the UIC's 102 of containers 100. This can include a bar code reader or any of a number of other readers and image capture devices as well as other sensors and readers. It is pointed out that a preferred embodiment is a multiscan device for scanning multiple containers held within a tray. Once scanned, the scanned UIC 102 information is processed by a processing system 411 (e.g., a microprocessor and associated software) and the information obtained can be stored in a memory 410 (which can be removable memory or remotely located memory (including cloud-based memory systems)). This information can form part of a data record 102r associated with the UIC 102. This data record 102r associates the contents of the container 100 with the UIC 102, which can then be tracked through an entire transit chain. Additional information can be input into the data record 102r through a variety of sources. Additionally, the data record 102r (or portions thereof) can be output from the apparatus 400 to other devices and locations. For example, the records 102r and any associated data can be transmitted (e.g., using any long distance data transmission media to remote locations where it can be stored and/or processed). In preferred implementation, the apparatus, comprises a multiscan device capable of reading (e.g., scanning a RFID), at substantially the same time, a plurality of UIC's arranged on a plurality of containers that are loaded in tray configured to enable such a purpose.

The embodiment depicted in FIG. 4 is a portable apparatus that can be used at a remote location, such as a farm where produce products (also referred to herein as produce) are harvested. In other implementations, alternate apparatus embodiments can be used. In broadest implementations, common sensors can be used to read UIC's 102 of the containers 100. Such sensors can be RFID readers or optical sensors or other suitable devices depending on the nature of the scanned articles. In one example, image capture devices, such as standard photo image capture chip found in smart phone cameras can be used. Although, many other optical recognition systems can also be used. Even small tablet devices with optical capture systems can be used (e.g., a device like an iPad (manufactured by Apple)). Additionally, alternative detectors can be used to recognize the identifiers 102. For example, if the UIC 102 comprises a RFID tag, the apparatus can include RFID sensors capable of detecting RFID identifiers.

In the depicted embodiment, the apparatus 400 includes a scanning bed 404 for supporting a tray 200 on the device 400. The scanning bed 404 can include a transparent protective window 402 that protects underlying optical reader(s) 401. In such a configuration, the readers 401 arranged under the scanning bed 404 can image overhead containers 100 through the overhead protective window 402. This enables the readers 401 to image the identifier codes 102 of the containers 100 inside the tray 200 resting upon the scanning bed 404. In alternate embodiments, the readers 401 can be arranged at other locations convenient to read the identifiers 102 at the bottoms of the containers 100. Additionally, other arrangements and positions of the readers 401 can be employed to image identifiers 102 located at positions other than at the bottoms of the containers and tray (100, 200 respectively).

The disclosure points out that a wide range of read and scanning devices can be used as the reader 401. These can include, laser scanners, LED scanners, photographic scanners, simple 1-D barcode readers, or 2-D barcode readers, or any other image recognition/reader device capable of reading the machine readable UIC's 102 (e.g., barcodes) at the bottom of the containers 100.

Additionally, some embodiments can include an alignment feature 409 that enables improved alignment of a tray 200 so that the containers 100 are adequately aligned with the readers 401. In this embodiment, alignment feature 409 is just a simple mechanical alignment tab, arranged such that when the tray 200 is pushed into physical contact with the tab, the tray 200 is in sufficient alignment to enable the readers 401 to image the UIC's 102. Many different types of alignment features 409 can be used in association with the apparatus 400 to correctly align the tray 200 and thereby the containers 100 with respect to reader(s) 401.

Additionally, the apparatus 400 can include ancillary scanning systems 405 capable of obtaining further machine readable information. In some cases, these scanning systems can be suitable for scanning other items such as harvester ID badges, pallet identifiers, or other identifiers, to be associated with specific ones of the containers. In one embodiment the ancillary scanning systems 405 can comprise a hand held optical reader associated with the apparatus 400. Additionally, optical readers 405 can include, without limitation, standard barcode readers, portable electronic devices with image capture capability, cell phones with cameras, tablet computing devices with cameras, and so on. These can be inside the apparatus 400 or exterior to the apparatus (such as shown here). They can be connected by physical connectors 406 or wirelessly depending on the devices. Physical connectors 406 can use optical fiber, metal wires, or a variety of other conduits. Additionally the ancillary scanning device 405 can interface with the apparatus 400 with a wireless connection. The ancillary scanning system 405 is not limited to the above and can be configured for scanning many different pieces of supplemental information. For example, the system 405 can scan an employee identifier (e.g., a badge with a machine readable identifier) or other persons that have handled the container 100. Examples include but are not limited to ID badge for a harvester or other harvester ID's, pallet identifiers, vehicle ID's, tray identifiers and many other pieces of visual information. Importantly, the device can be configured to scan other than optically recognizable identifiers. Other examples can include RFID identification or other modes. This information can be introduced into a data record 102r associated with the container 100.

It is pointed out that the apparatus can include a control system 408 that enables user input and can include a processor (e.g., 411) and a memory system (e.g., 410) for storing information (e.g., data records 102r, as well as additional information). Additionally, the memory system 410 can include removable and non-removable memory devices. Such can include portable memories like cell phone memory, tablet memory, USB memory sticks as well as many other portable memory devices.

Additionally, in some embodiments, additional inputs can include a wide range of sensor inputs. Such inputs and input devices can include but are not limited to navigation systems (e.g., GPS location systems, cell phone location systems, robotic navigation systems, etc.), temperature sensors, humidity sensors, ground moisture sensors, direct information input devices, weight sensors. For example weighing devices that can weigh trays, containers, and produce. In some embodiments, a pressure activated weighing devices can be used, as can other weighing devices. For example, as shown here, a sensor includes a scale 404w that can be integrated as a portion of the scanning bed 404. In another implementation, a keyboard activated device can be used to provide many different types of input information.

Additionally, a wireless communication device 409 can be used with the apparatus 400. It can be a permanently integrated wireless receiver/transmitter unit or a plug in unit. Such a device 409 can be used to receive and/or transmit wireless information to and from the apparatus 400 via a wide range of wireless communication systems known to those of ordinary skill in the art.

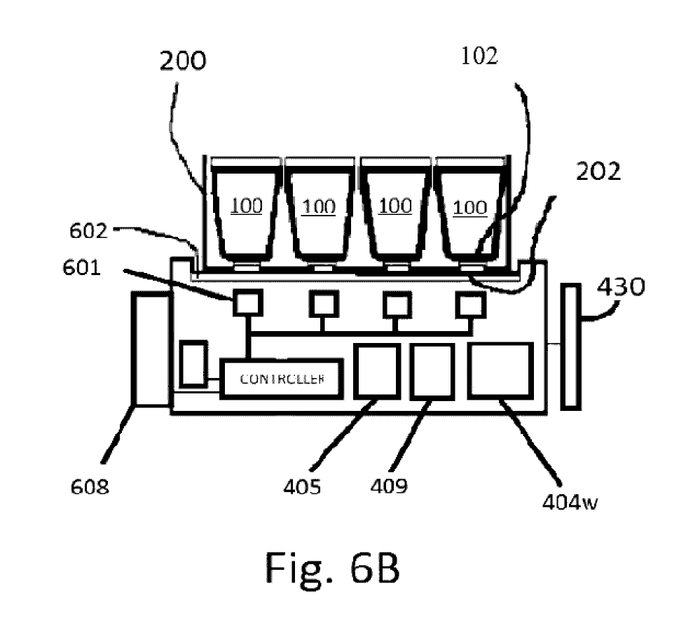

FIG. 5 is a simplified schematic depiction of a control/processing system 408 that can be used with a scanning apparatus in accordance with the principles of the invention. A data record 102r pertaining to a container 100 associated with the identifier 102 can be one or more of generated, processed, or stored by the processor 411 and memory 410 of the apparatus 400. Various pieces of information (e.g., metadata concerning the container 100 and its contents), inputs and control instructions can be provided as inputs 420 the various apparatuses described herein. Inputs 420 can be supplied using any of a number of methods and devices appropriate for entering appropriate data into the system. These devices can include but are not limited to keyboards, touch screens, data entry ports, wireless data entry, or using portable electronic devices such as tablet devices or smart phones, as well as any of a number of other modes. The readers 401, ancillary scanning devices 405, and scales 404w comprise some of the inputs 420 contemplated here. Additionally, the system 408 can output 430 information generated by (e.g., processor 411) or stored in (e.g., memory 410).

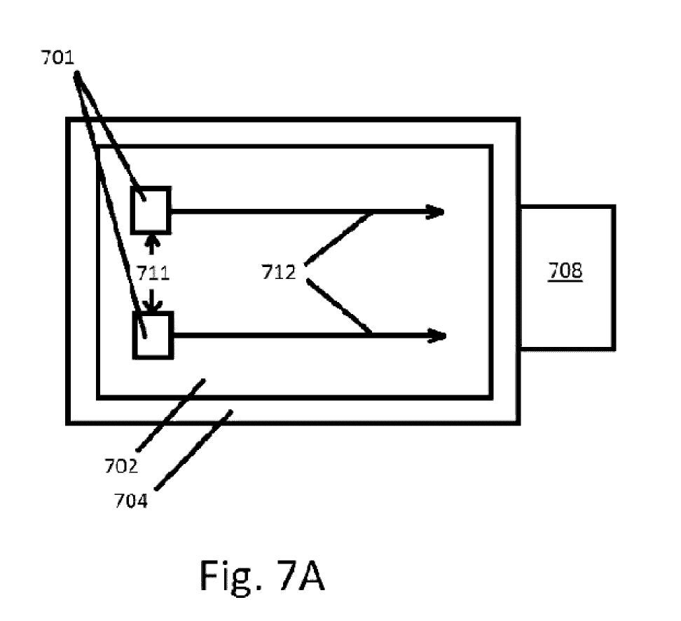

FIGS. 6A & 6B depict various views of one possible implementation of the apparatus. FIG. 6A depicts a schematic plan view of the apparatus 600 (analogous to 400). This view depicts a scanning bed 604 and an associated transparent protective window 602 arranged to protect the plurality of underlying optical reader(s) 601 (analogous to the readers 401 of FIG. 5). The readers 601 being arranged to enable the readers to image or otherwise read container identifiers 102 (or other identifiable marks) for containers 100 arranged in a tray 200 that is placed on the scanning bed 604. Examples of such readers 601 can include, without limitation, barcode readers, portable electronic devices, cameras, or any device with image capture capability, and so on, configured to read the machine readable UIC's 102 of the containers 100. In this embodiment, a control system 608 (analogous to 408 of FIGS. 4 & 5) is arranged near the protective cover 602 and the scanning bed 604.

Referring also to the side section view of FIG. 6B, the embodiment features eight (8) optical readers 601 arranged such that they can image eight (8) different container identifiers 102 through tray viewing windows 202 (and protective cover 602 of apparatus 600) of when the tray 200 is rested on the scanning bed 604. One such arrangement is configured to image the identifiers 102 of the tray 200 and container 200 in a combination similar to that shown in FIG. 3A. It is pointed out that the optical readers 601 depicted here are configured such that slight degrees of misalignment of the container identifiers 102 do not impair the ability of the reader 601 to read the identifier. Additionally, some embodiments can be employed such that the optical readers 601 are positioned and configured to read more than one identifier 102 at a time. The embodiments can include scales 404w, transceivers 409, ancillary inputs and or readers 405, as well as many other systems. The system 600 includes many control systems shown collectively here as block 608. Additionally, the embodiments can output information 430 for use in other systems.

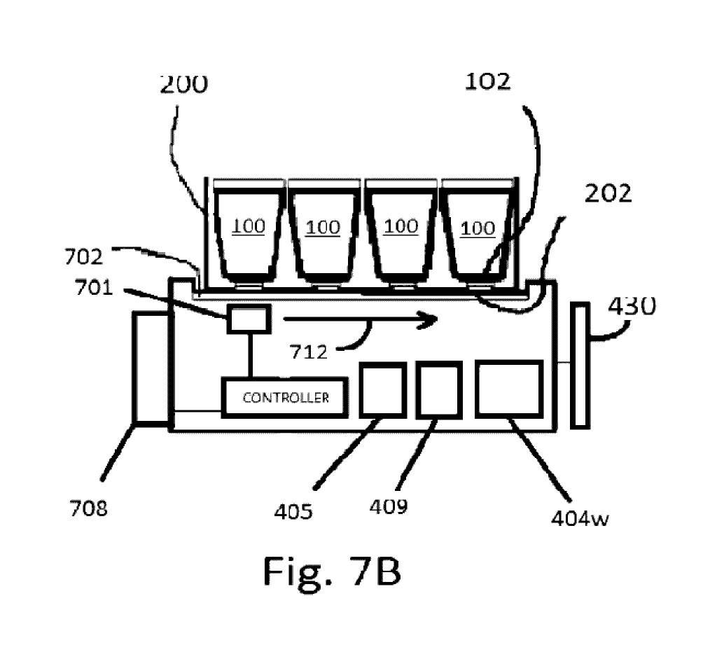

FIGS. 7A & 7B describes another embodiment 700 can include fewer optical readers while still addressing important aspects of the inventions.

FIG. 7A depicts a schematic plan view of the embodiment showing how one possible implementation can be used to accomplish aspects of the invention. The apparatus 700 (analogous to 400) uses a plurality of optical readers 701 (analogous to 401) that are arranged side by side in the apparatus 700. The optical readers 701 are device(s) capable of reading barcodes or other identifying marks 102 as described above. In this application, each optical reader 701 is arranged to align generally with a set of windows 202 at the bottom the tray 200. In this implementation, each optical reader 701 is aligned with a corresponding row of windows 202 at the bottom of the tray 200. Additionally, the optical readers 701 can be progressively scanned from one end of the tray 200 to the other, reading the codes 102 as the readers 701 pass under each of the containers 100. In this way the optical readers 701 read the rows of identifiers 102 associated with containers 100.

Again, referencing the embodiment shown in FIGS. 7A & 7B, a pair of optical readers 701 are arranged, side by side, at a spaced apart distance 711 and underneath a scanning bed 704 capable of supporting a tray. The arrangement further enables each optical reader 701 to upwardly read a row of containers 100 in a tray 200 placed on top of the apparatus 700. As shown here, the readers 701 are configured such that they move 712 from one end of tray to the other with the readers 701 remaining in alignment with the rows of windows 202 in the bottoms of the trays. This will enable each reader to read the coded identifiers 102 of each container 100 as it passes under the associated container. Additionally, the optical readers 701 can be adjustable to accommodate differences sizes, shapes, and window arrangements for various trays and containers. Importantly, is the ability to read the identifiers 102 through appropriately arranged viewing windows 202 in the trays 200 as the readers 701 move progressively under each of the containers 100. Embodiments can include scales 404w, transceivers 409, ancillary inputs and or readers 405, as well as many other systems. The system 700 includes many control systems shown collectively here as block 708. Additionally, the embodiments can output information 430 for use in other systems.

In another embodiment, it is also contemplated that the tray 200 can be moved over stationary readers 701 enabling the readers to read the identifiers 102 as they pass over the readers 701.

Additionally, in other embodiments, the optical readers 701 can be adjustable to accommodate differences sizes, shapes, and window arrangements for various trays and containers. Importantly is the ability to read the identifiers 102 through appropriately arranged viewing windows 202 in the trays 200 (shown here at the bottoms of containers within a packaging tray).

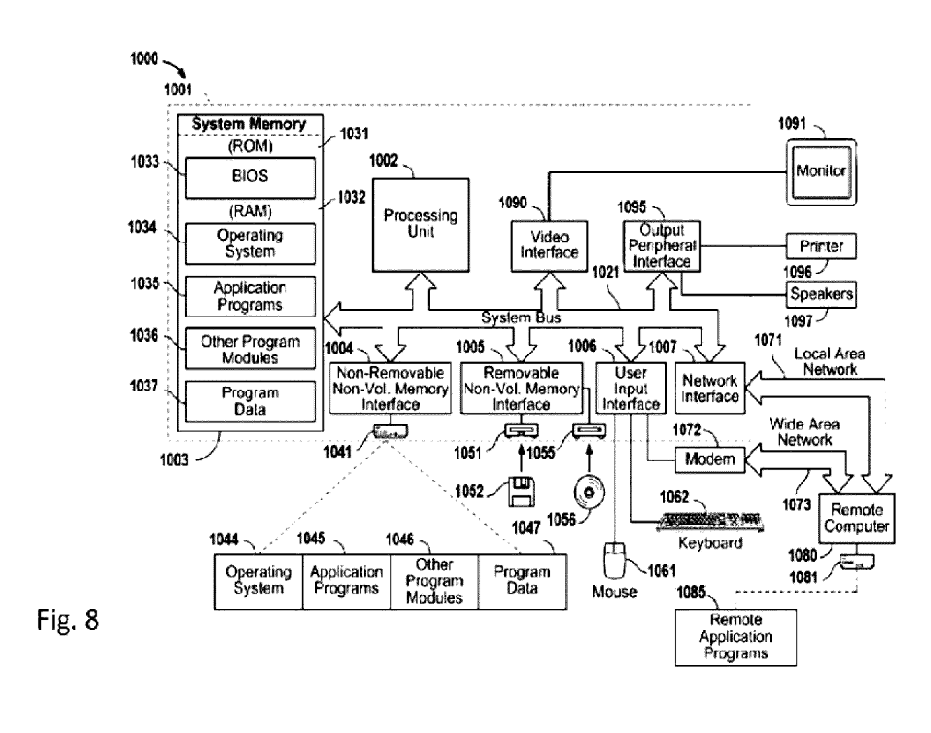

FIG. 8 illustrates an example of a suitable controller or computing system environment 1000 which can be used by various ones of the scanning apparatuses disclosed herein (e.g., 400, 600, 700, and others). Such a system and its associated software can be used in the foregoing technology as any of the processing, or control devices described herein. Multiple control systems, computing systems, and circuitry can be used to implement the control functions described herein. In one implementation the controller 1001 (i.e., 411 of FIG. 4) can be the microprocessor. This example is describes broadly, systems that can be implemented in a suitable device. It is pointed out that the systems described in FIG. 8 are for illustration only and many other features, embodiments, substitutes, and equivalents, as well as additional features can be implemented in accordance with the principles of the invention. Accordingly, the invention is not limited to the disclosed embodiments.

With continuing reference to FIG. 8, the apparatuses (e.g., 400, 600, 700, etc.) described herein can incorporate a general purpose computing device 1001 to form a part of the apparatus. Additionally, in other implementations the device 1001 can take the form of any of a number of different devices including, mobile electronic devices (e.g. tablet devices, smart phones, lap top computers and other portable computing devices, etc.). Components of computer system 1001 may include, but are not limited to, a processing unit 1002 (e.g., 411), a system memory 1003 (e.g., 410), and a system bus 1021 that couples various system components including the system memory to the processing unit 1002. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The general purpose computer (or control device) 1001 typically includes a variety of computer readable media. Computer readable media can be any available media that can be accessed by device 1001 and includes both volatile and nonvolatile media, removable and non-removable media, as well as firmware and software. By way of example, and not limitation, computer readable media may comprise computer storage media and communication media (e.g., 410). Computer storage media includes both volatile and nonvolatile memory devices, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, removable memory devices, remotely located memory devices and systems (e.g., cloud storage) or any other medium which can be used to store the desired information and which can accessed by computer 1001.

The system memory 1003 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1001, such as during start-up, is typically stored in ROM 1031. RAM 1032 typically contains data and/or program modules that are immediately accessible to and/or presently being operated on by processing unit 1002. By way of example, and not limitation, FIG. 8 also describes an operating system 1034, application programs 1035, other program modules 1036, and program data 1037 suitable for use in accordance with the principles of the invention.

In broadest applications, the computer 1001 can also include other removable/non-removable, volatile/nonvolatile, local/remote computer storage media. By way of example only, FIG. 8 illustrates a hard disk drive 1004 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, USB memory sticks, digital versatile disks, digital video tape, solid state RAM, solid state ROM, and the like. The hard disk drive 1041 is typically connected to the system bus 1021 through a non-removable memory interface such as interface 1004, and magnetic disk drive 1051 and optical disk drive 1055 are typically connected to the system bus 1021 by a removable memory interface, such as interface 1005.

The drives and their associated computer storage media discussed above and illustrated herein, provide storage of computer readable instructions, data structures, program modules and other data for the computer 1001. For example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information into the computer 1001 through input devices such as a keyboard 1062 and pointing device 1061, commonly referred to as a mouse, trackball or touch pad. Other input devices (not shown) may include a microphone, joystick, game pad, satellite dish, scanner, or the like. These and other input devices are often connected to the processing unit 1002 through a user input interface 1006 that is coupled to the system bus, but may be connected by other interface and bus structures, such as a parallel port, game port or a universal serial bus (USB). A monitor 1091 or other type of display device can also be connected to the system bus 1021 via an interface, such as a video interface 1009. In addition to the monitor, computers may also include other peripheral output devices such as speakers 1097 and printer 1096, which may be connected through an output peripheral interface 1009.

Additionally, the system 1001 may operate in a networked environment using logical connections to one or more remote computers, such as a remote computer 1008. The remote computer 1008 may be a personal computer, a server, a router, a network PC, a peer device or other common network node, a part of the scanning apparatus (e.g., 400) described herein, and typically includes many or all of the elements described above relative to the computer 1001, although only a memory storage device 1081 has been illustrated herein. The logical connections depicted here include a local area network (LAN) 1071 and a wide area network (WAN) 1003, but may also include other networks. Such networking environments are commonplace in offices, enterprise-wide computer networks, intranets and the Internet. Such a network can include transmitter/receivers can forming a part of systems (400, 600, 700, etc.) as described herein.

When used in a LAN networking environment, the computer 1001 is connected to the LAN 1071 through a network interface or adapter 1007. When used in a WAN networking environment, the computer 1001 typically includes a modem 1072 or other means for establishing communications over the WAN 1003, such as the Internet. The modem 1072, which may be internal or external, may be connected to the system bus 1021 via the user input interface 1006, or other appropriate mechanism. In a networked environment, program modules depicted relative to the computer 1001, or portions thereof, may be stored in the remote memory storage device. Additionally, the networked environment and include a transmit/receive system connected with a cloud computing system enabling at least one of remote storage and remote processing. By way of example, and not limitation, FIG. 8 illustrates remote application programs 1085 as residing on memory device 1081. It will be appreciated that the network connections shown are exemplary and other means of establishing a communications link between the computers may be used.

The above described systems, containers, and trays can be implemented in a number of novel ways to enhance container supply chain management and tracking. One advantageous implementation of the principles of the invention concerns as method of tracking containers and items at updating data concerning the containers along the way.

Aspects of the invention can include a tracking system that can include at least one of a reading scanning system (aspects of which are described in FIG. 8), a container type, and a tray type. The system can further comprise a database concerning each container and the contents of the container. Moreover, the system can be further comprised other reading scanning systems arranged at various points in a supply chain and after end use.

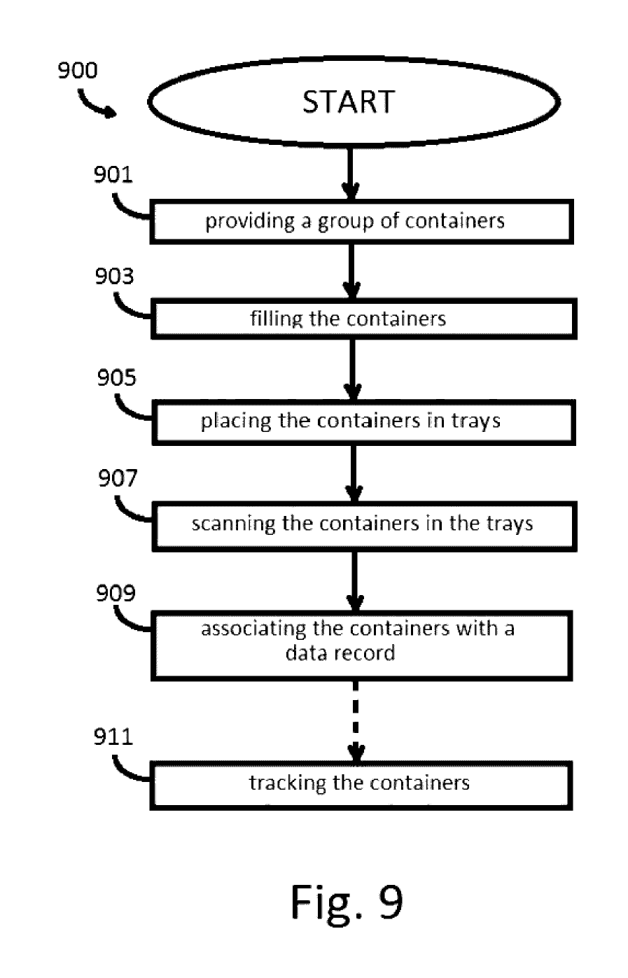

A flow diagram 900 of FIG. 9 is used to illustrate one method of packaging and tracking in accordance with the principles of the invention. The following process operations to be discussed need not be performed in order to enable the invention but are explained this way as a matter of convenience. It is to be pointed out that one convenient implementation is a computer-implemented method for accomplishing the steps described throughout this patent, although the implementation of the inventions described herein are not limited to computer-implemented methods.

In Step 901, a container 100 is provided for use with the process. This container 100 can be of a type discussed hereinabove. It is important that it has a machine readable unique identifier code 102 placed in a location such that when a container 100 is arranged in a tray, the code 102 is readable in accordance with the principles of the invention.

In Step 903, the container 100 has item(s) placed within it. The container is chosen to accommodate one or more of said items. The items can be of any type in need of tracking. In one particular implementation, the items can comprise produce items. For example, strawberries can be inserted into a container 100 sized to hold 1 pound of strawberries. However, there is no limitation on the number or type of items that can be inserted into particularly sized containers 100. In the embodiments discussed here, the containers can come pre-labeled and require no additional labeling.

In Step 905, the containers 100 are placed within trays 200 of a type discussed herein above. Such trays 200 will have at least one viewing window 202 (but generally a plurality of such windows) arranged such that they enable the scanning of the container 100 unique identifier codes 102 through the window(s) 202. Importantly, there need be no prior relation between tray 200 and container 100.

In Step 907, the tray 200 and the containers 100 contained therein are scanned. Such scanning can include, but is not limited to any method for reading the machine readable unique identifier codes 102 of the containers. Although containers can be scanned individually, one distinct advantage of the inventive technologies described herein, is that a plurality of containers 100 can be scanned at once or substantially contemporaneously. This can be done using apparatus like that described in FIGS. 4, 6, and 7 as well as many other devices. Importantly, such an approach substantially speeds up the process. This scanning can be done at any point in a supply chain and enable tracking at all stages thereafter. Compared to prior art systems, this approach has an extremely high reliability. Due to the inherent flexibility of the system, it will not matter who manufactured the containers, when they were bought, or what their other handling conditions were. All that matters is that they have a machine readable identifier 102 that can be read while in a tray 200. This adds a level of robustness, flexibility, and reliability that the prior art simply does not have.

In Step 909, upon scanning, the container 100 is associated with a data record (e.g., record 102r) that can be used to track and/or update the transit of the item throughout the supply chain. Ideally, but not exclusively, the container 100 can be scanned at a time substantially contemporaneous with the step of loading the container (e.g., Step 903) but can occur at other points in the supply chain.

It is pointed out that the data record 102r can exist prior to the time of scanning (Step 909) with a set of pre-determined data and merely associating the container 100 (and its associated identifier 102) with a previously created data set containing generalized information about a container. This generalized data, for the purposes of this disclosure, will be referred to a metadata. This metadata concerns a wide variety of information that is pertinent to the contents of the container or specific information concerning the container itself and can concern a wide variety of additional information. Some example inputs or pre-determined information that a user may wish to use are SKU information, a desired target weights, and barcode layouts. Other useful inputs can include grower information, ranch information, plot identification, varietal information, etc. It is specifically pointed out that other relevant information can be input into systems operating in accordance with the principles of the invention.

Metadata pertinent to the container and/or contents can be entered directly at the apparatus (like 400, 600, 700 as well as others), remotely, or using of other modes like additional ancillary scanning (which is one of many inputs 420, that can be input with a variety of devices, e.g., scanners 405 or other instruments). A wide array of data concerning the container and/or its contents can be entered into the data record 102r.

In a first example, which uses a produce item, the metadata can include pre-harvest data, harvesting data, and post-harvest data as well as many other parameters.

Examples of pre-harvest data can include, but are not limited to names of produce growers, grower culture, type of produce, which varietals, a growing field, grower culture, fertilizers used, soil moisture content, how much water used, pesticides used and a vast array of other activities that take place before the produce is harvested. This can be used to track productivity, growing conditions, issues involving food safety (including, but not limited to food borne illnesses). Information such as specific data formats, SKU information, barcode layouts, and a virtually limitless amount of other data can be input.

Examples of harvesting data that can include be included in the data record 102r. This harvest data can include, but is not limited to, a tray identifier (e.g., 102) which can include another machine readable ID code which can be scanned by an apparatus in accordance with the principles of the invention. Such information can also be obtained using an ancillary scanner (e.g., 405) as well as other devices or directly input. One important piece of such data can be the identity of the harvesting farm worker (the harvester). A harvester ID code can be used and tracked using the systems disclosed here. For example, each harvester can be given an ID badge having a machine readable unique identifier code that can be read by an apparatus (e.g., 400 or ancillary systems) or ancillary scanner. This information can then be used to track containers and harvesters for food safety, food quality, worker productivity, or even pay and other harvest tracking. A weight of produce can be tracked to determine if the amount of produce in the containers is within an acceptable range. specific positioning coordinates (e.g., GPS coordinates can be supplied for the harvest location, date, time, and other specific harvesting information can be supplied for a harvest location, all of which can be included in the appropriate data record 102r. Temperature, humidity, as well as other harvest conditions can also be input into the data record 102r as can a vast array of activities that take place during harvesting. It is specifically pointed out that other relevant information can be input into systems operating in accordance with the principles of the invention.

One particularly useful attribute of the invention is using post harvest information to facilitate transit tracking, supply chain management, and obtain follow up tracking information. For example, containers 100 can be associated with an identifier code of the tray 200 and the tray 200 can be tracked. Even more advantageously, the data record 102r can be used to track larger bulk shipments. For example, once a container 100 is filled 903, placed in a tray 905, and scanned 907, it is typically placed on a pallet and taken to a desired location where it undergoes further processing and/or transit. In one example implementation, a pallet can have a machine readable unique identifier code (a pallet identifier) affixed to the pallet. That pallet identifier can also be scanned and associated (one implementation of Step 909) with the data record 102r for every container 100 loaded on the pallet. This can enable all of the containers to be efficiently tracked by tracking the pallet alone.

Advantageously, prior to Step 909, there needs to be no prior relationship between pallets, trays, and containers. The relationship between these element need be establish only when scanned (e.g., in the field). Additionally, as soon as scanned, a series of relationships between containers and content, trays, and pallets as well as other transit vessels (trucks, train cars, aircraft, etc.) can be defined via the data record 102r for each container.

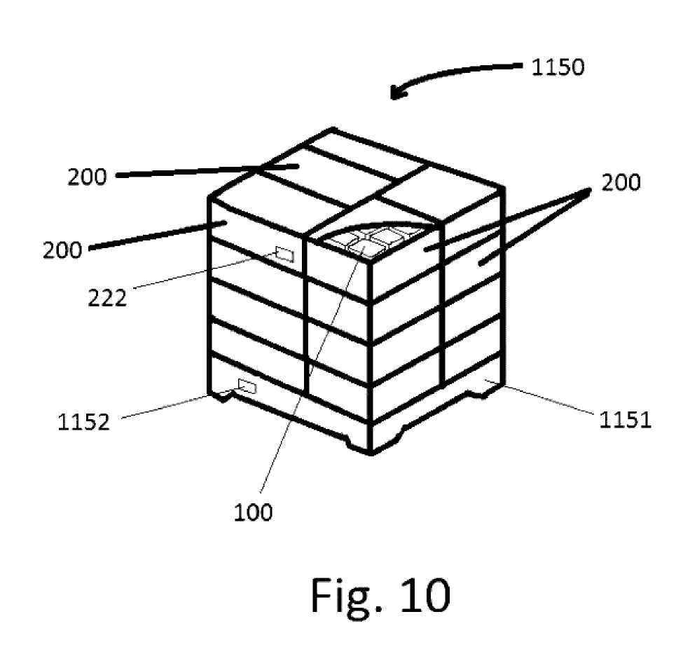

One approach can be briefly illustrated with respect to FIG. 10, which depicts a loaded pallet 1150. The pallet 1151 can be any of a number of different shipping pallets used in various industries. As illustrated here the pallet 1151 is a common 40 inch by 48 inch wooden shipping pallet. Although the principles of the inventions can be applied over a vast range of bulk transit packages, for convenience sake, a wooden agricultural shipping package is used in this example. This pallet 1151 also has a pallet identifier 1152 which can comprise a machine readable identifier code that is of a type disclosed elsewhere in this disclosure. Additionally, it is pointed out that such can be an RFID identifier that can be scanned as well. During loading the pallet identifier 1152 can be scanned (for example, using ancillary scanner 405, manual input, or other inputs) or otherwise inputted and associated with each data record 102r for at container 100 loaded onto the pallet 1152. Shown here, pallet 1151 has a plurality of trays 200 loaded thereon. Additionally, each tray 200 has loaded therein a plurality of containers 100. Additionally, in some embodiments, the tray 200 can have a tray identifier code 222. In this particular case the code 222 is a machine readable identifier. Importantly, none of the identifiers 102, 222, 1152, need be associated prior to a final scanning of the identifiers with the apparatus disclosed herein.

Thus, using the principles of the invention, a set of containers 100 can be placed in a tray 200 scanned together and placed on the pallet 1151. The pallet identifier 1152 can be scanned with the same device (e.g., 400, ancillary scanner 405). Thus, in Step 909, each data record 102r for each container 100 on the pallet 1151 now associates the container 100 with the pallet 1151 and/or a tray 200. Because systems generally ship in pallets, the containers 100 can be tracked simply by following the pallet identifier throughout the supply chain.

Accordingly, each container unique identification code 102 can be associated with a size of container, a type of contents to be inserted into the container (e.g., a type of produce product), a place of harvest, a date of harvest, the ID of the person who harvested the produce (the harvester), and an identification code specific to the precise container.

Referring back to FIG. 9, the disclosed steps can be associated with the operations of tracking the container at various stages in a supply chain (Step 911).

Tracking of the containers 100 throughout the supply chain is made more reliable using the systems and apparatuses disclosed in this specification. In one example, each container code 102 can be associated with at least one of a tray and a shipping pallet. From that point on, this can be used to track the containers all the way through the supply chain, transport chain, and to point of sale if desired. It is to be pointed out that the ideas here require no prior relationship between the identifiers of any of the containers, trays, and pallets. This is different than existing technologies. An advantage of this technology is that it can be aggregated right at the point of harvest or at any place in the shipping chain without pre-designation or identification of the components. The trays and containers can simply be fabricated, coded, and stored without regard for any relationship with each other. At the time of use (e.g., at harvesting) the containers, trays, and pallets are simply shipped to the destination of use and associated at a given time.

Usefully, they can be provided by different manufacturers, comprise different lots, even left over containers obtained at different time. All that is required is that they be scannable at time of use and especially in groups. Prior to scanning and associating (e.g., Steps 907 and 909) there need be no relationship between the individual containers. Nor need there be any relationship between the containers and the trays or any other components.

Some of the post harvest information that can be employed in accordance with the principles of the invention include, but are not limited to, proposed destinations, proposed modes of transport, care of product information, post sale information (e.g., consumer provided information), as well as many other pieces of interest. For example, a cooling location where product will be shipped from the harvest location can be associated with the data record 102r and associated container 100 (and contents). A packaging plant can be identified and entered into the data record 102r for the associated container 100. A final retail location could be can be associated with the data record 102r, a transit mode or deadline by which certain activities need be achieved can be added to the data record 102r. A date by which spoilage can occur can be included. Many such pieces of information can be introduced into the data record 102r. In fact, feedback can be solicited using the coded identifier 102 and the data record 102r. A request can be made of the end user to go to a website, input the identifier 102, and then answer a set of questions regarding the container 100 and its contents. Further post sale information concerning the produce can thereby be obtained. Thus, a container and its contents (here, produce products) can be tracked from the beginning of a supply chain (harvest) to the end (e.g., the end user). The great advantage of the existing technology is the very high degree of accuracy compared to existing technologies.

These, and other, steps can be performed using a non-transitory computer readable medium comprising the various instructions outlined above and elsewhere in this specification. All of these instructions being executable on a processor. Moreover, these steps can comprise a computer implemented method for scanning, tracking and tracing packaged items.

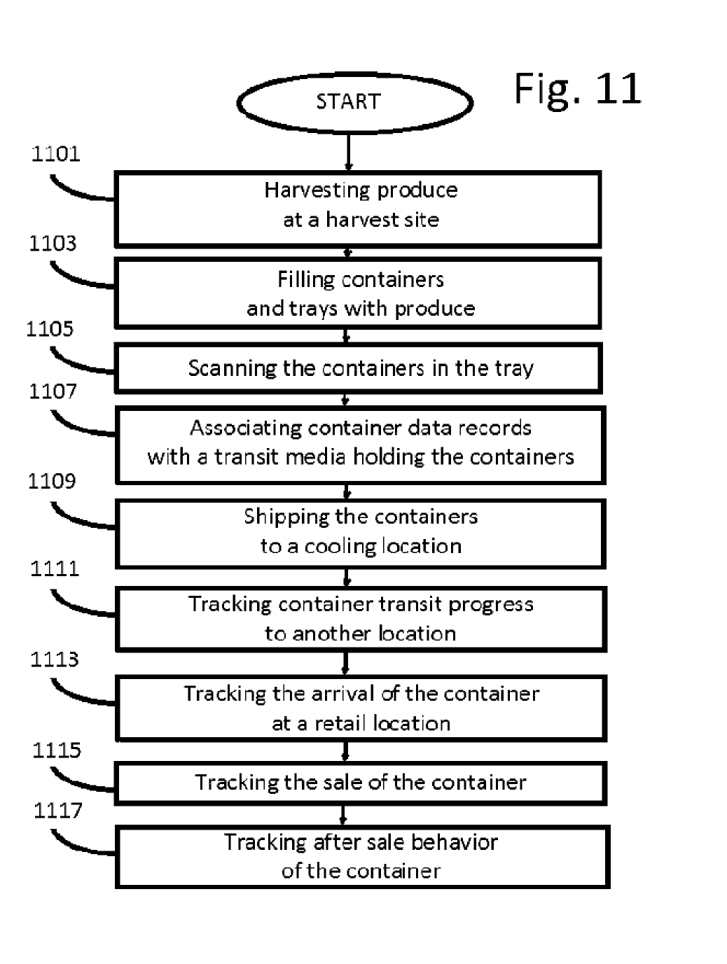

FIG. 11 provides a simplified example of how a product can be tracked/traced in a supply chain. To begin, produce can be harvested at a harvesting location 1101. Generally, this will involve filling containers 100 with produce and filling a tray 200 with containers 100 (Step 1103 (such as in Steps 903 & 905)). Trays 200 holding containers 100 will then be scanned (Step 1105 (such as in Step 907). At each step after 1105 the associated data records 102r can be tracked and amended. In this example, the trays 200 and containers 100 are loaded on a pallet 1151. The pallet 1151 (or other transit media, trays, trains, airplanes, trucks, or any other mode of carrying the containers) and containers 100 are associated with a set of data records 102r for the loaded containers 100 (Step 1107). In this example, the loaded pallet 1150 is shipped to a cooling facility which is entered into the data record 102r there by tracking the containers (Step 1109) to the cooling facility. Once cooled to a desired level, the pallet 1090 (and associated containers 100) is shipped via a transit mode (truck, plane, train, ship, etc.) to various locations. The progress and mode of transit can be tracked (Step 1111). The retail location (or a series of intermediate locations) is reached and the data record 102r is updated to reflect this information (Step 1113). The product (container 100) is sold to a consumer (Step 1115) and the data record 102r is updated to track the sale. Further, after sale behavior and product status can be and/or followed up on (product satisfaction, food safety, customer suggestions, etc.)(Step 1117). The forgoing example is but one possible implementation tracking agricultural products in a supply chain in accordance with the principles of the invention.

The disclosure further explains that a wide variety of traceability information can be obtained after the sale of the container (also importantly the contents of the container 100) to a customer. The tracking ability described in the patent can also be used to trace where a container (and its contents) has been. Importantly, from any endpoint, this patent discloses systems and methods can be used to trace a product all the way back to a point of origin. For example, a product can be traces all the way back to point of harvest and all information related to that harvest. The after sale behavior can be used to provide important information (Step 1117). When referring to a produce harvesting situation this methodology can be used to enhance food safety and reduce or track food borne illness. At point of harvest, the containers can be filled and scanned to associate a produce item with a container (e.g., 100) and a data record is thereby associated with the produce (Steps 1101, 1103, 1105, 1107). Information can be entered the data record (e.g., 102r) (Step 1107). Including information that can include, but is not limited to, the farm and location where the produce was harvested, the person harvesting the produce and loading the container, the date and time of harvest, as well as other information such as desired. To the extent it is desirable, the cooling information can be entered into the data record 102r (Step 1109) although not required to practice the invention. The cooling information can include a time from harvest until it reaches cooling facility, the specific cooling facility, and so on. Importantly, the record 102r can be updated at every step along the way by scanning an identifier associated with the produce (the container UIC 102, a pallet identifier 1152 associated with a set of containers, etc.). Additionally, the produce and container can be tracked at each step along a supply chain (e.g., Steps 1111, 1113) with any desired associated information added and updated. At any point along the chain, food spoilage, container damage, etc, can be tracked and scanned and entered into the record 102r. Once the produce (container 102) is sold to a consumer (Step 1115), a time and place of sale can be entered into the record 102r. In one example, this can be done by scanning at the point of sale. Moreover, post sale information can provide extremely valuable information (obtained at Step 1117) to various parties. As referred to above, one particularly useful aspect is to use all of this information to provide traceability that can improve food safety. For example, this post sale information can be used to report spoilage or sickness or a wide variety of other matters. For example, if a consumer becomes sick due to some sort of food safety issue, this traceability information can be used to trace the food back to its origin and at all points between. For example, the source of food safety hazard can be traced by site or or process or other factors to determine a source. It can be traced, to a harvesting farm that may have flawed handling processes, a particular harvesting employee, a transport company, a cooling facility, a food processor, an inventory management issue, or anywhere along the chain that is tracked by the data record 102r. Temperatures and locations were the contents are routed can be track as well as many other factors. Because a produce product can be associated accurately, right from the point of harvest (or even earlier in some cases) and be scanned and tracked through an entire system, the reliability is very high. And vastly higher reliability than other technologies that may attempt to do similar things.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Further, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. A method of packaging and tracking containers and their contents, the method comprising,
providing a plurality of containers, each having thereon a unique identifier code, the identifier code being in a machine readable format;
filling the container with an item;
inserting the containers into a tray having a viewing window;
scanning the unique identifier codes of the containers through the viewing window; and
associating the unique identifier code with a data record for the container.

2. The method of claim 1, wherein said filling the container with an item occurs prior to scanning of the containers in the tray.

3. The method of claim 2, wherein
the item comprises agricultural produce;
the filling of the container is accomplished at a produce harvest site;
the scanning the unique identifier codes is conducted at the harvest site; and
the unique identifier code and associated data record are associated with said agricultural produce.

4. The method of claim 3,
wherein the filling of the container includes harvesting the produce by a harvester having a harvester identifier code; and
wherein the harvester identifier code is included in the data record.

5. The method of claim 4 wherein said scanning comprises scanning the harvester identifier code substantially contemporaneous with said filling of the container.

6. The method of claim 3 wherein metadata concerning the item can be included in the data record for each container.

7. The method of claim 4 wherein metadata concerning the produce an be included in the data record for each container and wherein said meta data comprises at least one of growing information, harvesting information, and post harvest information concerning the produce.

8. The method of claim 3 further comprising,
loading said tray onto a pallet having a machine readable pallet identifier code;
performing an ancillary scanning of the pallet identifier code; and
associating the pallet identifier code with the data record for the container.

9. The method of claim 3, further comprising storing said data record in a memory.

10. The method of claim 9 wherein the memory is located remotely from the harvest site and wherein the method further comprises transmitting at least some of said data entry to the memory.

11. The method of claim 3 wherein the unique identifier can be tracked and scanned at various locations throughout a supply chain managing the disposition of the container.

12. The method of claim 1 further comprising tracking the container through a supply chain by periodically scanning the unique identifier of the container as it moves through different points in the supply chain.

13. A scanning system comprising:
a scanning bed, suitable for supporting a tray that holds a plurality of containers arranged such that an identifier code for each container is viewable through at least one viewing window of the tray;
a imaging system operable to read the identifier codes through the at least one viewing window;
a processor for processing the identifier codes and associated each code with a data record that also includes related metadata concerning contents of the container; and
a memory for storing data record.

14. The scanning system of claim 13 wherein the scanning system further comprises
an alignment feature operable to assist in correctly aligning the tray when it is placed on the scanning bed; and
wherein the imaging system comprises a plurality of image sensors each positioned to capture an image of an associated one of the identifier codes through the at least one viewing window when the tray is aligned.

15. The scanning system of claim 14 wherein the scanning system further comprises a transmitter enabling the data record to be transmitted to a remote receiver.

16. The scanning system of claim 15 wherein
the memory of the scanning system is located remote from the scanning bed, and
the remote receiver enables receipt of said data record such that the memory can store the data record remotely from the scanning bed.

17. The scanning system of claim 14 further comprising an ancillary scanning device configured to scanning machine readable information.

18. The scanning system of claim 13 further comprising a scale suitable for weighing at least one of the tray and the containers.

19. A packaging system comprising:
a packaging tray suitable for holding a container and having at least one viewing window;
at plurality of containers, each having a unique identifier code arranged thereon; and
wherein each of the plurality of containers are arranged in the tray such that the identifier code is viewable through said at least one viewing window.

20. The packaging system of claim 19 wherein
the at least one viewing window of the tray comprises a plurality of said viewing windows; and
each container is arranged such that its identifier code is aligned in registry with an associated one of the plurality viewing windows.

21. The packaging system of claim 20 wherein
a bottom surface of the tray has formed therein the plurality of viewing windows;
the identifier codes are arranged at a bottom surface of the containers; and
wherein each container is arranged in the tray such that its identifier code is in registry with, and can be seen through, an associated one of said viewing windows at the bottom of the tray.
